(19) United States
(12) Patent Application Publication
(10) Pub. No.: US 2019/0389247 A1
(43) Pub. Date: Dec. 26, 2019

(54) VEHICLE WHEEL

(71) Applicant: HONDA MOTOR CO., LTD., Tokyo (JP)

(72) Inventors: Yusuke OSAWA, Wako-shi (JP); Toshinobu SAITO, Wako-shi (JP); Youichi KAMIYAMA, Wako-shi (JP)

(21) Appl. No.: 16/444,752

(22) Filed: Jun. 18, 2019

(30) Foreign Application Priority Data
Jun. 22, 2018 (JP) 2018-118594

(51) Int. Cl. B60B 21/02; G10K 11/172; B60C 19/00

(52) U.S. Cl. CPC B60B 21/026; B60B 2900/133; B60C 19/002; G10K 11/172

(57) ABSTRACT

Provided is a vehicle wheel to have a Helmholtz resonator mounted to a rim with an old structure, without circumferential grooves cut in the rim so as to have the Helmholtz resonator mounted therein. A vehicle wheel (1) includes a rim (11) formed by joining an inner rim (14a) and an outer rim (14b), and a sub air-chamber member (10) as a Helmholtz resonator, wherein the sub air-chamber member (10) is mounted to the rim (11) via a support member (20) held between the inner rim (14a) and the outer rim (14b).

### CROSS-REFERENCE TO RELATED APPLICATION

This application claims the benefit of priority to Japanese Patent Application No. 2018-118594 filed on Jun. 22, 2018, the disclosures of all of which are hereby incorporated by reference in their entireties.

### TECHNICAL FIELD

The present invention relates to a vehicle wheel.

### BACKGROUND OF THE INVENTION

A Helmholtz resonator arranged on an outer circumferential surface of a well portion of a wheel is known to have both edges thereof, protruding in a wheel width direction, engaged with circumferential grooves of a rim (see Japanese Patent application Publication No. 2012-45971, hereinafter referred to as Patent Document 1, for example). This Helmholtz resonator has both edges elastically deformed, when the resonator is pressed toward the outer circumferential surface of the well portion, and easily fitted into the circumferential grooves. Such a Helmholtz resonator can easily be attached to a wheel.

### SUMMARY OF THE INVENTION

### Problems to be Solved

However, such a conventional wheel (see Patent Document 1, for example) is required to have circumferential grooves cut in the rim so as to have the Helmholtz resonator mounted therein. This causes a problem that a manufacturing process of this wheel becomes complicated.

The present invention is intended to provide a vehicle wheel to have a Helmholtz resonator mounted to a rim with an old structure, without circumferential grooves cut in the rim so as to have the Helmholtz resonator mounted therein.

### Solution to Problem

A vehicle wheel according to the present invention, to solve the above problems, includes a rim formed by joining an inner rim and an outer rim, and a sub air-chamber member as a Helmholtz resonator, wherein the sub air-chamber member is mounted to the rim via a support member held between the inner rim and the outer rim.

### Advantageous Effects of the Invention

According to the present invention, a vehicle wheel has a Helmholtz resonator mounted to a rim with an old structure, without circumferential grooves cut in the rim so as to have the Helmholtz resonator mounted therein.

### BRIEF DESCRIPTION OF DRAWINGS

FIG. 1 is a partial perspective view of a vehicle wheel according to an embodiment of the present invention;

FIG. 2 is a cross-sectional view taken along a line II-II in FIG. 1;

FIG. 3 is an overall perspective view of a main body of a sub air-chamber member;

FIG. 4 is a cross-sectional view taken along a line IV-IV in FIG. 3; and

FIG. 5 illustrates a configuration of a vehicle wheel according to a modification.

### EMBODIMENTS OF THE INVENTION

Next, a vehicle wheel according to an embodiment of the present invention will be described in detail with reference to the drawings as required. Note that in the drawings to be referenced, “X” indicates a wheel circumferential direction, “Y” indicates a wheel width direction, and “Z” indicates a wheel radial direction. Hereinafter, an overall configuration of a vehicle wheel will be described first, and then a sub air-chamber member as a Helmholtz resonator will be described.

### <Overall Configuration of Vehicle Wheel>

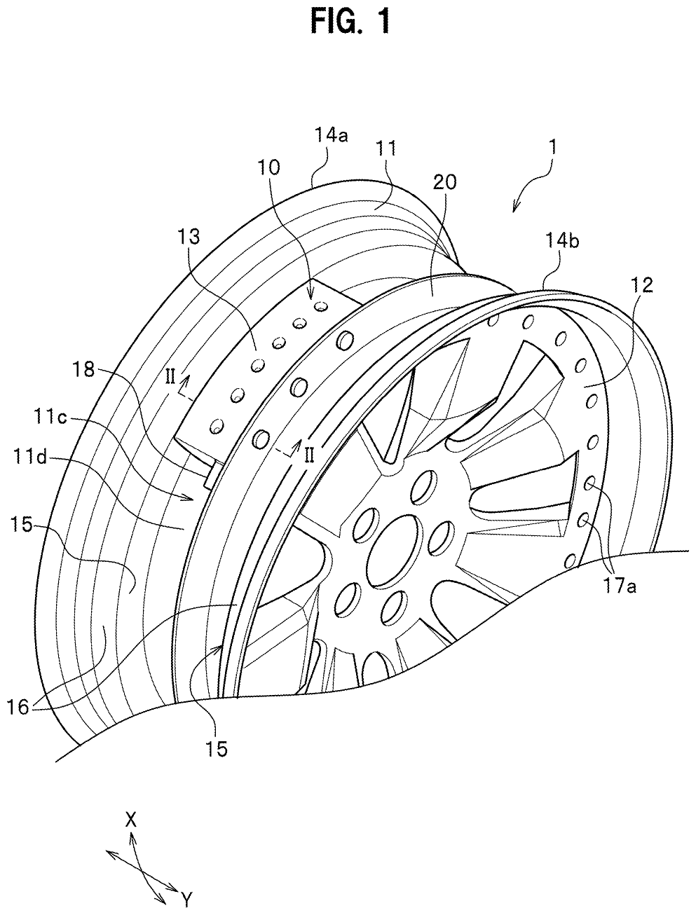

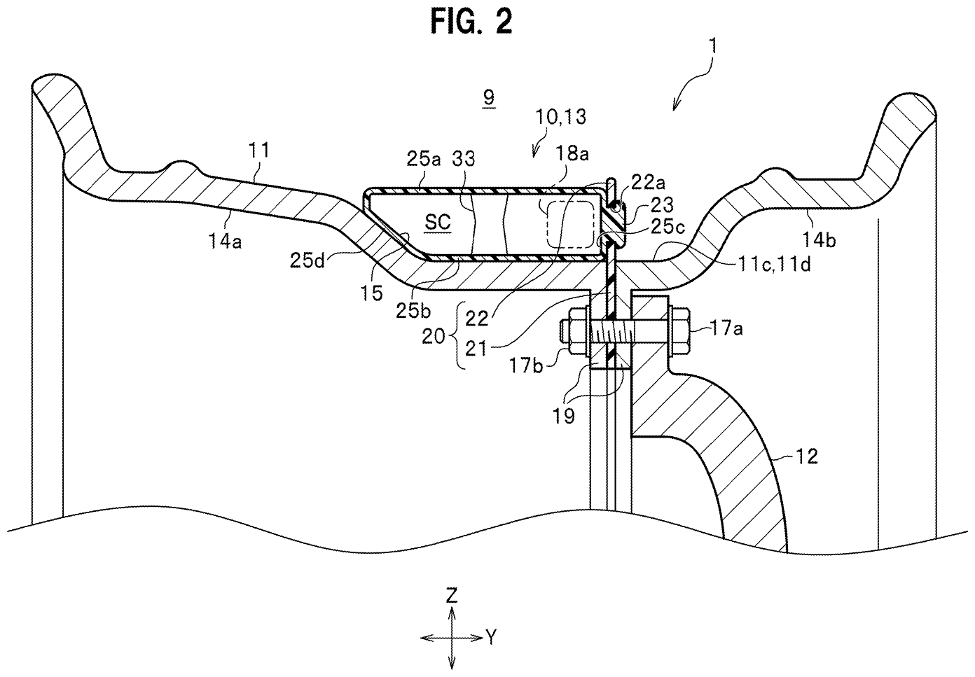

FIG. 1 is a partial perspective view of a vehicle wheel 1 according to an embodiment of the present invention. FIG. 2 is a cross-sectional view taken along a line II-II in FIG. 1. The vehicle wheel 1 according to the present embodiment is a three-piece wheel having an inner rim 14a, an outer rim 14b, and a disk 12 integrally fastened in the wheel width direction Y by a plurality of piercing bolts 17a, as shown in FIG. 1. The vehicle wheel 1 is assumed to be made of a light metal such as an aluminum alloy and a magnesium alloy.

A rim 11 is composed of the inner rim 14a and the outer rim 14b, and includes a well portion 11c that is located between bead seats 16 respectively formed at both ends in the wheel width direction Y and is recessed toward a wheel shaft in the wheel radial direction. An outer circumferential surface 11d of the well portion 11c defined by a bottom surface of the recess has substantially the same diameter across the wheel width direction Y about the wheel shaft. In addition, the rim 11 has a pair of rising portions 15 to rise on both sides in the wheel width direction Y from the outer circumferential surface 11d of the well portion 11c toward the bead seats 16. In FIG. 1, a reference numeral 10 denotes a sub air-chamber member to be described later in detail, and is mounted to the rim 11 via a support member 20.

As shown in FIG. 2, the vehicle wheel 1 of the present embodiment is stacked, from an outer side (right side in FIG. 2) to an inner side (left side in FIG. 2) in the vehicle width direction, with the disk 12, the outer rim 14b, the support member 20 of the sub air-chamber member 10, and the inner rim 14a, in this order, and fastened by the piercing bolts 17a and nuts 17b.

The disk 12 is adapted to couple the rim 11 to a hub (not shown). The outer rim 14b forms the well portion 11c of the outer half of the rim 11, while the inner rim 14a forms the well portion 11c of the inner half of the rim 11. The outer rim 14b and the inner rim 14a have respective joint flanges 19 to be bent inward in the wheel radial direction Z from a mutual seam and extend straight. These joint flanges 19 hold the support member 20 of the sub air-chamber member 10 to be described next.

### <Sub Air-chamber Member>

The sub air-chamber member 10 includes the support member 20 annularly extending in the wheel circumferential direction X, and a main body 13 mounted to the rim 11 via the support member 20, as shown in FIG. 1. The support member 20 is formed of a plate which is flat in the wheel width direction Y, as shown in FIG. 2. As described above, the support member 20 includes a held portion 21 to be held between the outer rim 14b and the inner rim 14a by the joint flanges 19, and an extending portion 22 to extend from the held portion 21 toward the well portion 11c. The extending portion 22 is provided with a mounting hole 22a to mount the main body 13 therethrough.

The supporting member 20 of the present embodiment also serves as a sealing material to airtightly seal between the outer rim 14b and the inner rim 14a, and is assumed to be made of resin. However, the material of the support member 20 is not limited to resin, and can be formed of metal. Note that a reference numeral 33 in FIG. 2 denotes a bridge of the main body 13 to be described later.

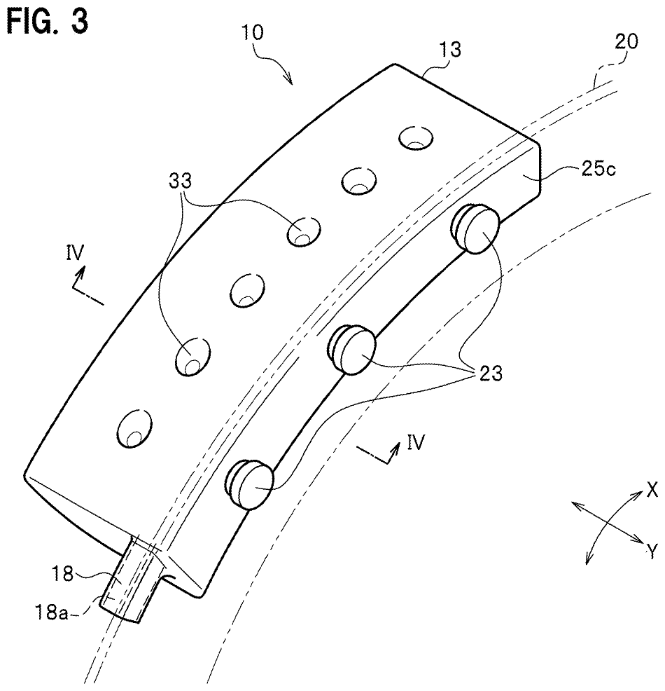

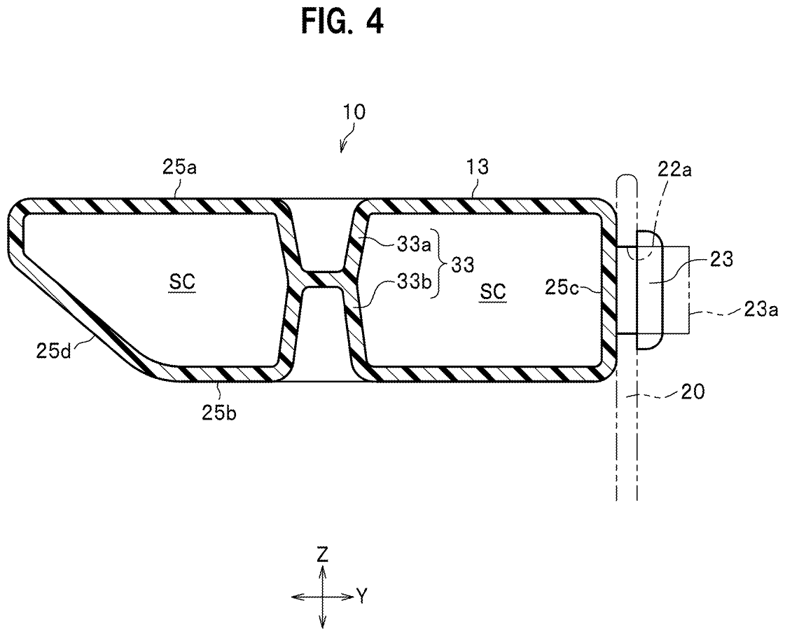

FIG. 3 is an overall perspective view of the main body 13. FIG. 4 is a cross-sectional view taken along a line IV-IV in FIG. 3. Note that the support member 20 of the sub air-chamber member 10 is indicated by virtual lines (two-dot chain lines) for the purpose of illustration in FIGS. 3 and 4. The main body 13 of the sub air-chamber member 10 is a member elongated in one direction, as shown in FIG. 3, and includes a tube 18 and a swaged projection 23. The main body 13 of the present embodiment is assumed to be a blow-molded or injection-molded product made of a thermoplastic resin such as polypropylene and polyamide, or the like, for example.

The main body 13 is curved in the longitudinal direction. That is, the main body 13 is formed to run along the wheel circumferential direction X, when attached to the outer circumferential surface 11d (see FIG. 1) of the well portion 11c (see FIG. 1) via the support member 20. The main body 13 is hollow inside. The hollow (not shown) defines a sub air-chamber SC (see FIG. 4) to be described later. A reference numeral 33 in FIG. 3 denotes a bridge.

The main body 13 is in a shape of a rectangular trapezoid elongated in the wheel width direction Y, in a cross sectional view orthogonal to the longitudinal direction (the wheel circumferential direction X in FIG. 3), defined by a bottom plate 25b, a top plate 25a, a side plate 25c, and an inclined plate 25d, as shown in FIG. 2.

The bottom plate 25b is formed of a plate extending along the wheel width direction Y so as to be substantially flat. The bottom plate 25b is formed to be curved in the wheel circumferential direction X (see FIG. 1) at substantially the same curvature as the outer circumferential surface 11d. The top plate 25a is formed of a plate extending in parallel with the bottom plate 25b at a predetermined distance.

The side plate 25c is formed of a plate to rise substantially vertically from an end, the closer one to the support member 20, in the wheel width direction Y of the bottom plate 25b and extend in parallel to the support member 20. The inclined plate 25d is formed of a plate to face the side plate 25c and extend along the rising portion 15. The top plate 25a, the bottom plate 25b, the side plate 25c, and the inclined plate 25d surround and define the sub air-chamber SC within the main body 13.

In addition, the main body 13 is formed to have a plurality of bridges 33 arranged in a row in the wheel circumferential direction X at equal intervals, as shown in FIG. 3. The bridge 33 is formed to have an upper joint portion 33a and a lower joint portion 33b joined to each other in the substantially center between the top plate 25a and the bottom plate 25b, as shown in FIG. 4. Note that the upper joint portion 33a is formed to have the top plate 25a partially recessed toward the bottom plate 25b. Additionally, the lower joint portion 33b is formed to have the bottom plate 25b partially recessed toward the top plate 25a.

The bridge 33 has a substantially cylindrical shape to partially connect the top plate 25a with the bottom plate 25b. The bridge 33 defines openings in a circular shape at corresponding positions of the main body 13, in a planar view as viewed from above and below, respectively. Note that the reference numeral 25c denotes a side plate and the reference numeral 25d denotes an inclined plate, in FIG. 4. Additionally, the reference numeral 23 denotes a swaged projection to be described later, and a reference numeral 23a denotes a resin material, indicated by an imaginary line (two-dot chain line), to be worked as the swaged projection.

Next, the tube 18 (see FIG. 1) will be described. The tube 18 is formed to protrude in the wheel circumferential direction X from the main body 13 at a position deviated to an end in the wheel width direction Y of the main body 13, as shown in FIG. 1. The tube 18 of the present embodiment is arranged adjacent to the support member 20.

The tube 18 is formed therein with a communication hole 18a, as shown in FIG. 3. The communication hole 18a communicates between the sub air-chamber SC formed within the main body 13 and a tire air-chamber 9 formed between the rim and a tire (not shown) above the well portion 11c, as shown in FIG. 2.

Next, the swaged projection 23 (see FIG. 2) will be described. The swaged projection 23 is formed by the resin material of the main body 13, extending from the main body 13 through the mounting hole 22a of the support member 20 onto the side of the support member 20 opposite from the main body 13, being radially more expanded than the mounting hole 22a, as shown in FIG. 2. The swaged projection 23 protrudes in the wheel width direction Y from the side plate 25c of the main body 13, as shown in FIG. 3. In the present embodiment, the three swaged projections 23 are formed in a row in the wheel circumferential direction.

The swaged projection 23 is formed in such a way that the resin material 23a in a cylindrical shape, protruding from the main body 13, is inserted through the mounting hole 22a of the support member 20 and then its front end is swaged by ultrasonic vibration, as shown in FIG. 4. Note that the four main bodies 13 are mounted, by swaging, in the circumferential direction of the support member 20 at equal intervals, although not shown.

The vehicle wheel 1 as described above is assembled in such a way that the main body 13 is mounted to the support member 20 to form an assembly of the sub air-chamber member 10, as shown in FIG. 4. Then, the support member 20 is held between the joint flange 19 of the outer rim 14b and the joint flange 19 of the inner rim 14a, and these are fastened, together with the disk 12, by the piercing bolt 17a and the nut 17b, as shown in FIG. 2. The main body 13 of the sub air-chamber member 10 is mounted to the rim 11 via the support member 20 so as to be arranged on the outer circumferential surface 11d of the well portion 11c. This completes a series of works of assembling the vehicle wheel 1.

Next, a description will be given of advantageous effects of the vehicle wheel 1 of the present embodiment. The vehicle wheel 1 of the present embodiment has the sub air-chamber member 10 mounted to the rim 11 via the support member 20, which is held between the inner rim 14a and the outer rim 14b. Therefore, the vehicle wheel 1 has no need of circumferential grooves to mount the Helmholtz resonator (the main body 13 of the sub air-chamber member 10) therein being cut in the rim 11, unlike the conventional wheel (see Patent Document 1, for example). This allows the vehicle wheel 1 to have a simplified manufacturing process of the rim 11 as compared with the conventional one, to make manufacturing costs reduced.

In addition, in the vehicle wheel 1 of the present embodiment, the support member 20 is formed of an annular plate to be held and fastened between the inner rim 14a and the outer rim 14b. According to the vehicle wheel 1, the support member 20 also serves as a seal material between the inner rim 14a and the outer rim 14b.

Hereinabove, the present embodiment has been described, but the present invention is not limited thereto and can be implemented in various forms. In the embodiment, the main body 13 of the sub air-chamber member 10 and the support member 20 are joined by swaging. However, the connection between the main body 13 and the support member 20 is not limited to the connection by swaging, and any connection such as adhesion, welding, fastening, other mechanical connection, or the like may be applied.

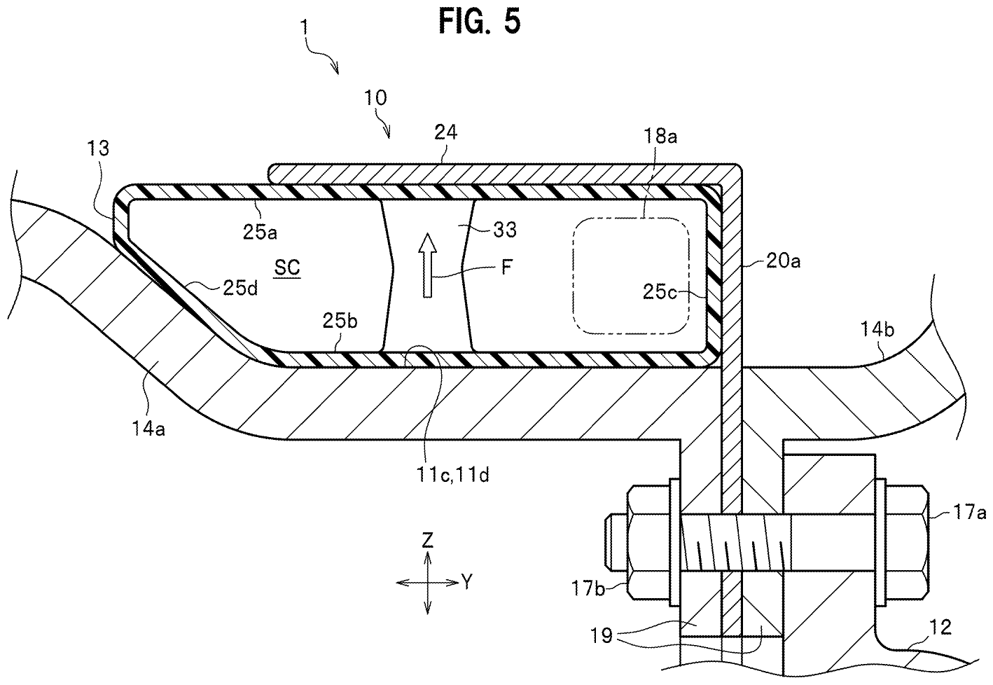

FIG. 5 illustrates a configuration of a vehicle wheel 1 according to a modification. Note that the same components in FIG. 5 as those in the embodiment are denoted by the same reference numerals, and the detailed descriptions thereof will be omitted. As shown in FIG. 5, this vehicle wheel 1 according to the modification includes a support member 20a having a cover portion 24, in place of the support member 20 (see FIG. 2) in the embodiment. The support member 20a is assumed to be made of a metal plate.

The support member 20a in this vehicle wheel 1 according to the modification extends outward in the wheel radial direction Z from the joint flanges 19, and is then bent to the main body 13 to form the cover portion 24. The cover portion 24 is in contact with the upper surface of the top plate 25a of the main body 13.

This vehicle wheel 1, when a centrifugal force F acts on the main body 13 at the time of the wheel being rotated, allows the cover portion 24 to hold the main body 13 onto the outer circumferential surface 11d of the well portion 11c so as to resist the centrifugal force F. In addition, this vehicle wheel 1 allows the swaged projection 23 (see FIG. 2) to be dispensed with, to simplify mounting the main body 13 to the support member 20a. However, this vehicle wheel 1 according to the modification does not necessarily exclude a direct connection between the main body 13 and the support member 20a. Then, the main body 13 and the support member 20a may be connected to each other by adhesion, welding, swaging, fastening, other mechanical connection, or the like.

The embodiment assumes a three-piece wheel of an overhead type, in which the disk 12 is arranged at an outer part of the rim, as described above, but the present invention can alternatively be applied to that of an underhead type or a sandwich type. In addition, the present invention is also applicable to a two-piece wheel, as long as either the inner rim 14a or the outer rim 14b is integrated with the disk 12 and the support member 20 can be held between the inner rim 14a and the outer rim 14b. Additionally, the embodiment assumes a wheel having the inner rim 14a and the outer rim 14b fastened by the piercing bolts 17a and the nuts 17b. However, the present invention can also be applied to one having the inner rim 14a and the outer rim 14b joined by welding, as long as the support member 20 can be held between the inner rim 14a and the outer rim 14b.

What is claimed is:

1. A vehicle wheel comprising:
a rim formed by joining an inner rim and an outer rim; and
a sub air-chamber member as a Helmholtz resonator,
wherein the sub air-chamber member is mounted to the rim via a support member held between the inner rim and the outer rim.

2. The vehicle wheel as claimed in claim 1, wherein
the support member is formed of an annular plate to be arranged between the inner rim and the outer rim, and
the inner rim, the support member, and the outer rim are integrally fastened in this order in a wheel width direction.
